(19) United States
(12) Patent Application Publication
(10) Pub. No.: US 2006/0250206 A1
(43) Pub. Date: Nov. 9, 2006

(54) Rod iginition coil

(76) Inventors: Konstntin Lindenthal, Blaichach (DE); Reinhold Herrmann, Stuttgart (DE); Thomas Breckle, Bihlerdorf (DE); Nikolaus Hautmann, Weitnau (DE); Wolfgang Ahmann, Oberstdorf (DE)

Correspondence Address: KENYON & KENYON LLP, ONE BROADWAY, NEW YORK, NY, 10004, US

(21) Appl. No.: 10/537,669

(22) PCT Filed: Oct. 15, 2003
(86) PCT No.: PCT/DE03/03416

§ 371 Date: May 31, 2006

(30) Foreign Application Priority Data
Dec. 5, 2002 (DE) 102 56 802.2

(51) Int. Cl. H01F 27/02

(52) U.S. Cl. 336/96

(57) ABSTRACT

Proposed is a pencil ignition coil including a rod core (14), a first coil form (16) having a first coil winding (18), and a second coil form having a second coil winding (26). In accordance with the present invention, the second coil form is formed by an assembly including the first coil form (16), the first coil winding (18), and a potting compound (24) for the first coil winding (18) (FIG. 4).

### FIELD OF THE INVENTION

The present invention is based on a pencil ignition coil for ignition systems, in particular a pencil ignition coil for use in an internal combustion engine of a motor vehicle, according to the type defined in greater detail in the preamble of claim 1.

### BACKGROUND INFORMATION

Such a pencil ignition coil is known from German Patent No. DE 199 27 820, and is used for high voltage supply to a spark plug of an internal combustion engine of a motor vehicle. This pencil ignition coil has a substantially concentric structure and includes a centrally located rod core made of a magnetizable material. The rod core is surrounded by an inner coil form, the so-called “secondary coil form”, on which is located a winding which serves as a secondary coil. This winding is connected to a high-voltage terminal which can be electrically connected to the spark plug. The secondary coil is in turn surrounded by an outer coil form, the so-called “primary coil form”, which carries a second winding forming the primary winding. The primary winding is connected via control electronics to a terminal for connection to a low-voltage source. The assembly including the secondary coil form, the secondary winding, the primary coil form, and the primary winding is potted with a potting material composed, for example, of epoxy resin and is arranged in a coil housing which is provided on its outside with a metallic flux return shell for closing a magnetic circuit including the rod core.

A pencil ignition coil designed in this manner is also known from German Patent No. 299 18 100. The housing of this pencil ignition coil is at least partially made of electrically conductive plastic so that the housing and the metallic flux return shell are at the same electrical potential, thus ruling out partial discharges between a central portion of the housing and the metallic flux return shell during the operation of the pencil ignition coil.

The known pencil ignition coils described above each have a diameter which may be too large for the mounting space available in an internal combustion engine.

### SUMMARY OF THE INVENTION

The pencil ignition coil of the present invention, in which the second coil form is formed by an assembly including the first coil form, the first coil winding, and a potting compound for the first coil winding, has the advantage, as compared to known pencil ignition coils, that it can have a smaller diameter and therefore requires less mounting space in an internal combustion engine. This is accomplished because the ignition coil of the present invention has no separate second coil form. Rather, the second coil form is constituted by the components that are present in the pencil ignition coil anyway. The first coil winding is potted; the second coil winding being wound directly on the potting compound for the first coil winding.

Thus, the pencil ignition coil of the present invention has a simplified design, less components, reduced material use, and an optimized size as compared to the related art. This, in turn, reduces manufacturing costs. Moreover, compared to the known pencil ignition coils described above, the pencil ignition coil of the present invention features optimized electrical properties and improved durability in temperatures ranging from −50° C. to +150° C.

In a particularly compact embodiment of the pencil ignition coil of the present invention, contacts for the first winding are embedded in the potting compound composed, for example, of epoxy resin, so that the contacts are also part of the assembly that forms the second coil form and constitutes a so-called “secondary casting”.

As is usual with pencil ignition coils, the first coil form of the pencil ignition coil of the present invention, which surrounds the rod core, forms the so-called “secondary coil form” on which is located the first coil winding forming the secondary winding. The secondary winding is then connected to the contacts that form high-voltage terminals and are used for connection to the corresponding spark plug. The second coil winding forms the so-called “primary winding”, which is connected to a low-voltage source.

The pencil ignition coil of the present invention can be manufactured, for example, by initially making the assembly of the first coil form, the first coil winding, and the potting compound, and then providing this assembly with the second coil winding and fitting it into a plastic housing along with a rod core. The pencil ignition coil is completed with a metallic flux return shell, a protective jacket for the spark plug, a seal which is located at the periphery and which, when in the installed position, is in contact with the engine block of the internal combustion engine, a connector for connection to a low-voltage source and other required components, which are usual and will not be further described herein.

In an alternative embodiment of the pencil ignition coil of the present invention, the housing is formed by a flux return device, which usually takes the form of a sleeve-shaped, metallic flux return shell. The housing or the metallic flux return shell is spaced by air gap an from the second coil winding arranged on the assembly including the first coil form, the first coil winding, and the potting compound.

In a special embodiment of the pencil ignition coil of the present invention, the assembly which includes the first coil form, the first coil winding, and the potting compound and on which is located the second coil winding is fixed with an elastomer. This elastomer can also fix the rod core, form a protective jacket for a spark plug to be connected to the pencil ignition coil, a retaining or protective ring for the pencil ignition coil and, moreover, a mechanical fixing for the flux return member and/or a terminal connector.

This pencil ignition coil containing the elastomer is manufactured by sliding the assembly provided with the primary winding onto a rod core, for example, an iron core or a magnetic core, and completing it with the terminal connector and the flux return member. The electrical connections are all made during this process. The assembly so produced is then inserted into a mold and filled and/or covered with an elastomer. This operation produces the embedding for the rod core or iron core and the mechanical fixing thereof, the protective jacket for the spark plug, the seal, i.e., the retaining ring, an at least partial embedding of the primary winding in the elastomer, as well as the mechanical fixing of the flux return member and of the terminal connector. This embodiment eliminates the need for an otherwise usual heat-shrink tubing and for a buffer, which were used to isolate the iron core. This results in a pencil ignition coil having less components, but identical electrical properties. This, in turn, reduces costs.

### BRIEF DESCRIPTION OF THE DRAWINGS

FIG. 1 is a part sectional view of a pencil ignition coil according to the present invention.

FIG. 2 is an enlarged sectional view of region II which is surrounded with a broken line in FIG. 1.

FIG. 3 shows a secondary casting of the pencil ignition coil of FIG. 1.

FIG. 4 shows the secondary casting of FIG. 3 with a primary winding.

FIG. 5 depicts a second embodiment of a pencil ignition coil according to the present invention in a view corresponding to FIG. 2.

FIG. 6 is a longitudinal section through a third embodiment of a pencil ignition coil according to the present invention.

FIG. 7 shows the pencil ignition coil of FIG. 6 prior to filling and covering with an elastomer.

### DETAILED DESCRIPTION

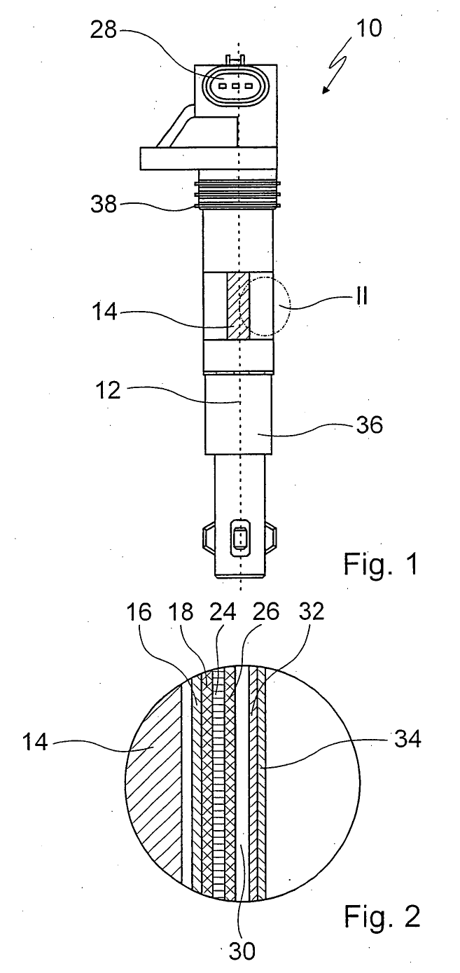

FIGS. 1 through 4 show a pencil ignition coil 10, which is designed for connection to a spark plug (not specifically shown here) and is insertable into a longitudinal hole in the cylinder head of an internal combustion engine (not specifically shown here either).

Pencil ignition coil 10 includes a centrally located, longitudinal rod core 14 which is made of iron or else of a magnet and is arranged coaxially with a longitudinal axis 12.

A first coil form 16, the so-called “secondary coil form”, is arranged concentrically around rod core 14. A first coil winding 18, the so-called “secondary winding”, is placed on coil form 16. Secondary winding 18 can be connected at its output to the spark plug for high voltage supply and is potted, together with contacts 20 and 22, with a potting compound 24 in a mold, forming an assembly which includes secondary coil core 16, secondary winding 18, and potting compound 24, and constitutes a so-called “secondary casting”, and which represents a second coil form, the so-called “primary coil form”, for a second coil winding 26, the so-called “primary winding”. Second coil winding 26 is connected to a connector 28, which is used to connect pencil ignition coil 10 to a low-voltage source of the corresponding motor vehicle.

Primary winding 26 is surrounded by an air gap 30 which is bounded radially on the outside by an ignition coil housing 32 that is made of plastic and is in contact with a sleeve-shaped, metallic flux return shell 34 which is used as the flux return member of a magnetic circuit of pencil ignition coil 10, the magnetic circuit including rod core 14.

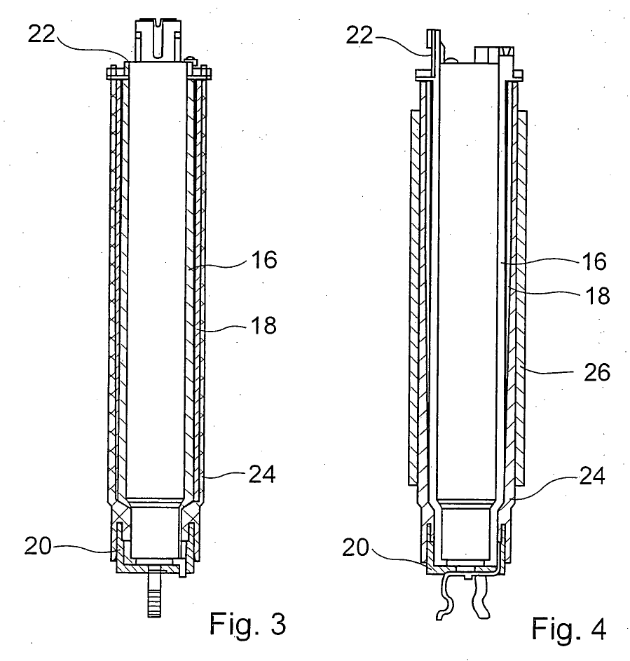

Pencil ignition coil 10, which is shown in FIG. 1 in the assembled condition, is manufactured as follows: initially, secondary winding 18 is placed on secondary coil form 16 and, along with contacts 20 and 22, is potted with epoxy resin potting compound 24 in a mold to form the secondary casting, resulting in the assembly shown in FIG. 3. This assembly is then used as a primary coil form for primary winding 26 to manufacture the assembly shown in FIG. 4. The latter assembly is then fitted into plastic housing 32. Also mounted are metallic flux return shell 34, a protective jacket 36, a seal 38, connector 28, and other required components which will not be further explained herein.

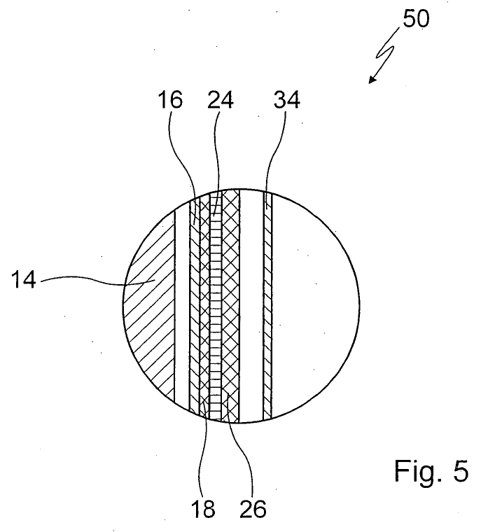

FIG. 5 is a detail view of a second embodiment of a pencil ignition coil 50 which is substantially equivalent to that of FIGS. 1 through 4, but differs therefrom in that it has no plastic housing. Rather, metallic flux return shell 34 is mounted directly over air gap 30 surrounding primary winding 26, which further reduces the space required for mounting pencil ignition coil 50 in the cylinder head of the internal combustion engine.

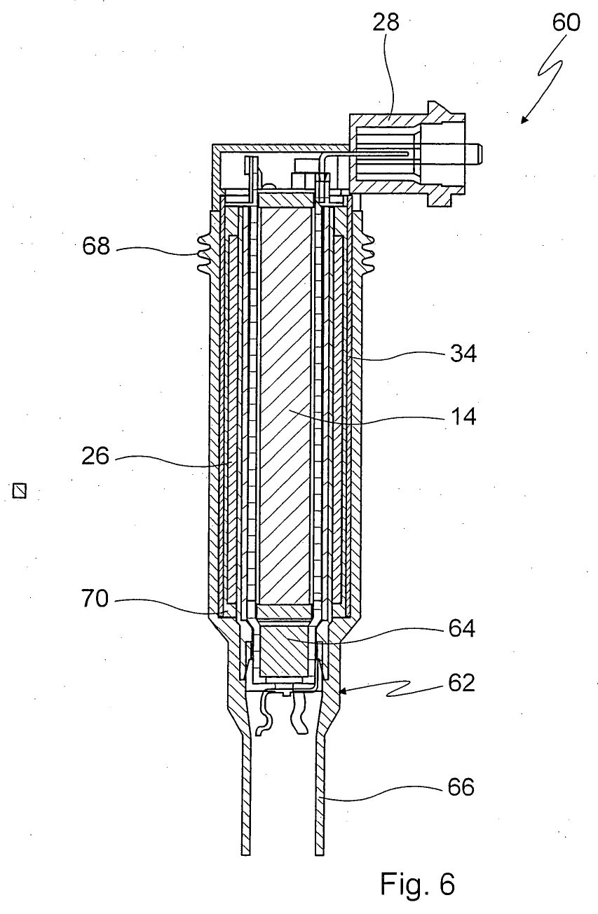

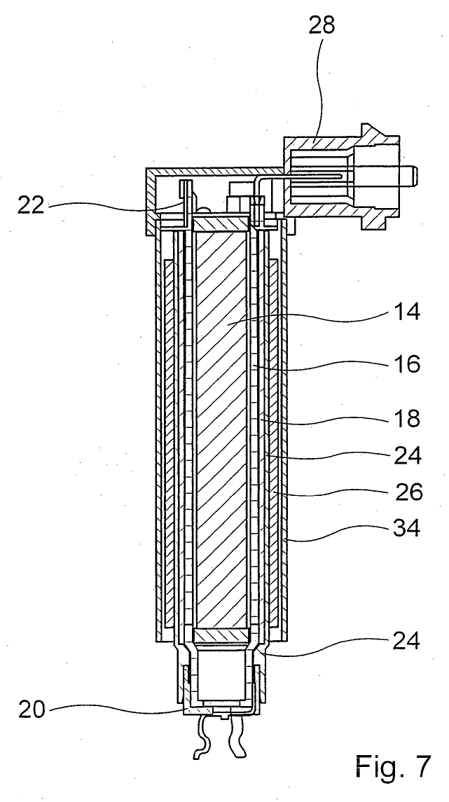

FIGS. 6 and 7 show a further embodiment of a pencil ignition coil 60 whose design is also substantially equivalent to that of the pencil ignition coil of FIGS. 1 through 4, but differs therefrom in that it is made with an elastomer 62 that has both functional properties and fixing properties.

Elastomer 62 fills an assembly including the electrical and magnetic components of pencil ignition coil 60 and covers this assembly, at least partially. This assembly is shown in more detail in FIG. 7 and contains at its center the assembly that is shown in FIG. 4 and includes secondary coil form 16, secondary winding 18, potting compound 24, primary winding 26, as well as contacts 20 and 22. Iron core 14 is inserted in this assembly or winding set. Moreover, this winding set is connected to connector 28 and surrounded by metallic flux return shell 34. During manufacture, the assembly assembled and electrically and magnetically connected in this manner is inserted into a mold and then filled and/or covered with elastomer 62. This operation produces a fixing, i.e., an embedding 64 for iron core 14, a protective jacket 66 for a spark plug to be connected to pencil ignition coil 60, a seal, i.e., retaining ring 68, which is in contact with the engine block of the internal combustion engine when ignition coil 60 is in the installed position, an embedding 70 for primary winding 26, as well as a mechanical fixing of metallic flux return shell 34 and of terminal connector 28.

1.-9. (canceled)

10. A pencil ignition coil, comprising:
a rod core;
a first coil form having a first coil winding; and
a second coil form having a second coil winding, wherein the second coil form is formed by an assembly including the first coil form, the first coil winding, and a potting compound for the first coil winding.

11. The pencil ignition coil as recited in claim 10, further comprising:
contacts for the first coil winding, the contacts being embedded in the potting compound and forming part of the assembly.

12. The pencil ignition coil as recited in claim 11, further comprising:
a flux return device bounding an air gap surrounding the first coil winding.

13. The pencil ignition coil as recited in claim 11, wherein the assembly is fixed with an elastomer.

14. The pencil ignition coil as recited in claim 13, wherein the rod core is fixed using the elastomer.

15. The pencil ignition coil as recited in claim 13, wherein the elastomer forms a protective jacket for a spark plug.

16. The pencil ignition coil as recited in claim 13, wherein the elastomer forms one of a retaining ring and a protective ring.

17. The pencil ignition coil as recited in claim 13, wherein the primary winding is at least partially embedded in the elastomer.

18. The pencil ignition coil as recited in claim 13, wherein the elastomer forms a mechanical fixing for at least one of a flux return member and a terminal connector.
